(19) United States
(12) Patent Application Publication
(10) Pub. No.: US 2023/0370249 A1
(43) Pub. Date: Nov. 16, 2023

(54) DATA ENCRYPTION AND ROUTING MIDDLEWARE

(71) Applicant: Made Daily LLC, Minneapolis, MN (US)

(72) Inventor: Pier Erik Hegeman, Saint Paul, MN (US)

(21) Appl. No.: 18/317,250

(22) Filed: May 15, 2023

Related U.S. Application Data
(60) Provisional application No. 63/364,742, filed on May 16, 2022.

(51) Int. Cl. H04L 9/08; H04L 9/32

(52) U.S. Cl. CPC H04L 9/0825; H04L 9/0861; H04L 9/3213

(57) ABSTRACT

An example system for transmitting secured data can include: a processor; memory encoding instructions which, when executed by the processor, cause the processor to: receive the secured data from a sender for a recipient, the secured data being encrypted using a first encryption mechanism; retrieve a second encryption mechanism associated with the recipient; transform the secured data using the second encryption mechanism; notify the recipient of the secured data; and deliver the secured data to the recipient, the secured data being encrypted using the second encryption mechanism.

### BACKGROUND

Data is encrypted between a sender and a recipient to protect its confidentiality and integrity. The process of encryption can be difficult, involving the potential use of private and/or public keys to encrypt and decrypt the secured data. Further, it is necessary for the sender and receiver to coordinate before encryption occurs so that the recipient is able to retrieve and decrypt the secured data upon receipt. Such processes can be time consuming and difficult to manage.

### SUMMARY

In one aspect, an example system for transmitting secured data can include: a processor; memory encoding instructions which, when executed by the processor, cause the processor to: receive the secured data from a sender for a recipient, the secured data being encrypted using a first encryption mechanism; retrieve a second encryption mechanism associated with the recipient; transform the secured data using the second encryption mechanism; notify the recipient of the secured data; and deliver the secured data to the recipient, the secured data being encrypted using the second encryption mechanism.

### DESCRIPTION OF THE FIGURES

FIG. 1 shows an example system for securing data sent between a sender and a recipient.

FIG. 2 shows logical components of an example middleware router of the system of FIG. 1.

FIG. 3 shows an example method for registering a sender or recipient on the system of FIG. 1.

FIG. 4 shows an example method for sending secured data using the system of FIG. 1.

FIG. 5 shows an example method for receiving secured data using the system of FIG. 1.

FIG. 6 shows an example method for creating a persistent session using the system of FIG. 1.

FIG. 7 shows example components of the middleware router of FIG. 2.

### DETAILED DESCRIPTION

Embodiments disclosed herein relate to data encryption and routing middleware.

In the examples provided herein, sending data through a secure middleware router can have various characteristics including, without limitation, that senders and recipients transferring sensitive data to one another do not need to coordinate how the data will be encrypted. In other words, the senders and recipients do not need to determine encryption algorithms, key lengths, key exchange protocols, etc. Further, in these examples, recipients can choose their own preferred method of receiving encrypted data. Finally, when in an end to end configuration, the data is secured because the middleware router may not decrypt the data routed therethrough.

As used herein, a recipient is a software or hardware system that is programmed to receive encrypted data from the middleware router. A key bundle is a collection of encryption keys used by a recipient to access encrypted data. A root secret is a passphrase or encryption key used to encrypt key material stored in the key bundle.

A Pre-shared Key (PSK) is a symmetric encryption key or secret that is stored on two systems for encrypting data. A Password Based Encryption (PBE) is a form of pre-shared key where the encryption key is derived from a client password/passphrase using a password-based key derivation algorithm. A Key Encryption Key (KEK) is an encryption key used to encrypt other keys. A Data Encryption Key (DEK) is an encryption key used to encrypt data. Finally, a Hardware Security Module (HSM) is a dedicated hardware device used for cryptography.

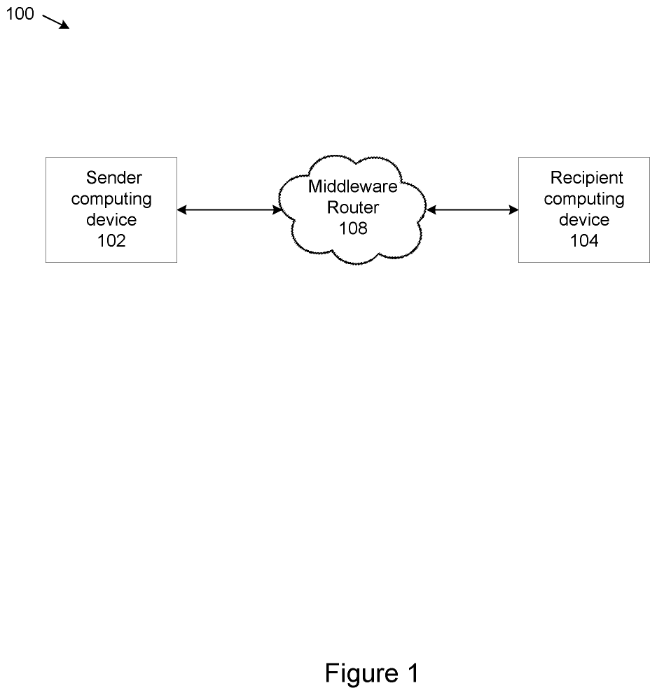

Referring now to FIG. 1, an example system 100 is shown for securing data sent from a sender to a recipient. As illustrated, the system 100 includes a sender computing device 102, a recipient computing device 104, and a middleware router 108.

In this example, the middleware router 108 facilitates the secure communication of data from the sender computing device 102 to the recipient computing device 104. As noted, this can include allowing the sender computing device 102 and/or the recipient computing device 104 to choose a desired method of securing the data. The middleware router 108 manages the encryption of the data sent from the sender computing device 102 to the recipient computing device 104 and performs any necessary transformation of that data therebetween. Optionally, when data transformation does not occur, the data can be further secured based upon the middleware router 108 being unable to decrypt the data sent through the system 100.

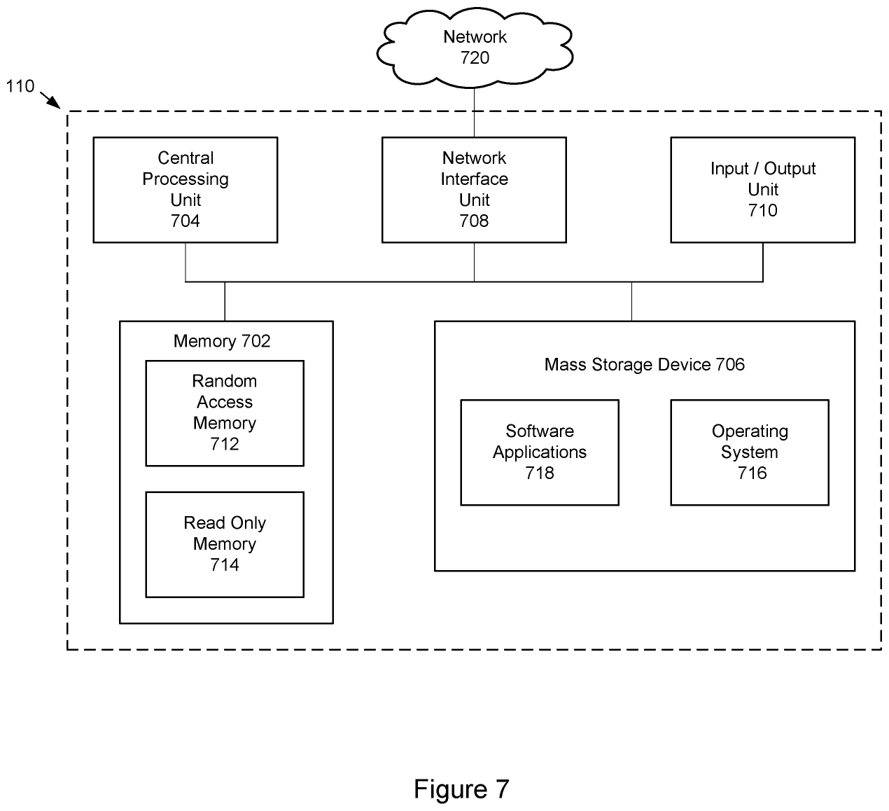

In example embodiments, the computing devices 102, 104 communicate with the middleware router 108 through a network (see, e.g., network 720 of FIG. 7), such as a local area network, a wide area network, a wireless or cellular communication network, the Internet, or the like.

While only a single sender computing device 102 and recipient computing device 104 are shown, the system 100 can include hundreds, thousands, or millions of such computing devices. Further, while the middleware router 108 is depicted as a single device, the middleware router 108 can be implemented as a series of server computers, such as within a server farm or cloud computing. Many configurations are possible.

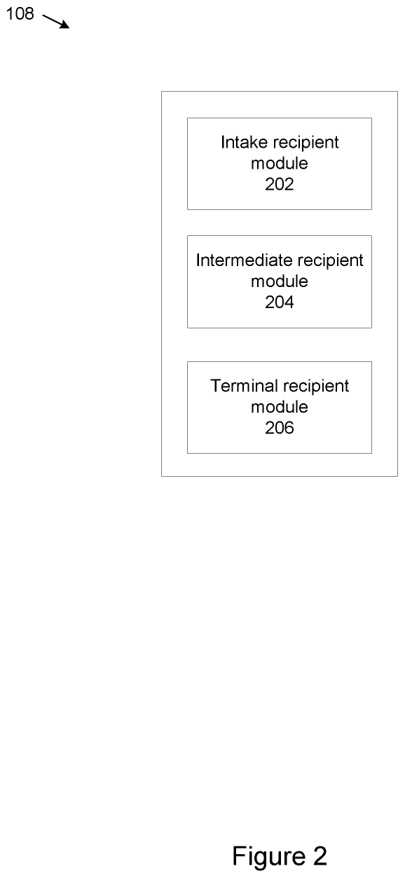

Referring now to FIG. 2, additional details are shown about the logical components of the middleware router 108. In this example, the middleware router 108 includes an intake recipient module 202, an intermediate recipient module 204, and a terminal recipient module 206.

In this example, the intake recipient module 202 is programmed to receive data from an external party, and the terminal recipient module 206 is programmed to send data to an external party. This can involve either pushing or pulling secured data from the sender computing device 102 to the recipient computing device 104.

For example, the terminal recipient module 206 can be configured to send the secured data synchronously to the recipient computing device 104; this is considered a “push” recipient. A push recipient must define the recipient computing device 104 and communication mechanism when the recipient computing device 104 is registered with the system 100. In the event of a connection failure, data to be sent to a push recipient can be added to a retry queue within the middleware router 108 to be sent later.

If the recipient computing device 104 cannot accept synchronous connections from the middleware router 108, the middleware router 108 can be configured to allow the recipient computing device 104 to pull the secured data from the middleware router 108 via a messages service. Pull recipients can either poll on an interval, or can be configured to receive a notification from the middleware router 108 when secured data is available (e.g., SMS, Webhook, etc.). If a notification is used, the notification type and location can be specified when the recipient computing device 104 is registered with the system 100.

For example, the intake recipient module 202 can be programmed to listen to a queue for a message with secured data from the sender computing device 102. Upon receipt, the intake recipient module 202 pulls the data into the middleware router 108 and delivers the data to the intermediate recipient module 204.

The sender computing device 102 can deliver the secured data to the middleware router 108 through many different mechanisms. For instance, the secured data can be transferred by facsimile or scanner, uploaded through a web-based or FTP-based interface, and/or uploaded through mobile or desktop clients on the sender computing device 102. In yet other examples, an Application Programming Interface (API) can be hosted by a third-party application, such as a web site, to provide the mechanism for the sender computing device 102 to deliver the secured data to the middleware router 108. In some embodiments, the sender computing device 102 can define one or multiple recipients for the secured data.

Once the routing and transformations have been completed by the intermediate recipient module 204, the intermediate recipient module 204 delivers the secured data to the terminal recipient module 206. The terminal recipient module 206 in turn, delivers the secured data to the recipient computing device 104.

There are again many ways that the secured data can be delivered to the recipient computing device 104. Examples of these include by web site, file system, and/or mobile or desktop applications. Other examples include a hardware device (e.g., memory stick or other media) and/or a software agent.

The intermediate recipient module 204 is programmed to perform routing and/or transformations on the secured data. For example, the intermediate recipient module 204 can identify one or more recipients who have accounts on the system 100 for delivery of the secured data. For instance, the intermediate recipient module 204 can be programmed to route the secured data relating to a patient sender to two doctor recipients in a health practice. In another example, the intermediate recipient module 204 can be programmed to route the secured data from a patient sender to both a data warehouse recipient and an electronic medical records recipient. Many different configurations are possible.

The intermediate recipient module 204 can also be programmed to transform the secured data, such as decrypting and encrypting the secured data using a different encryption method requested by the recipient computing device 104. For example, the intermediate recipient module 204 can be programmed to receive an encrypted data package from the sender computing device 102, transform it to a different encrypted format (e.g., JSON to CSV, or Excel to PDF), and pass it on to the recipient computing device 104.

In some examples, the intermediate recipient module 204 is executed in an isolated network that is not routable from the Internet. Further, the intermediate recipient module 204 can use encrypted keys that are stored in an HSM, which prevents export of key material and cannot be accessed by outside personnel. This results in greater security as the secured data is transformed and routed within the system 100.

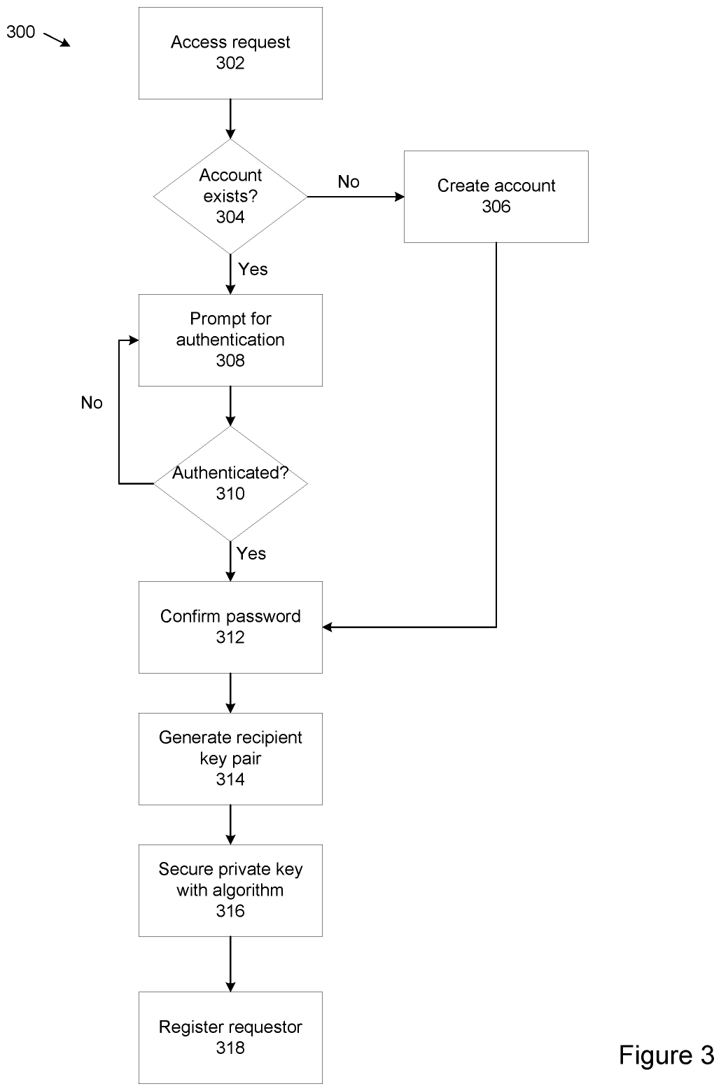

Referring now to FIG. 3, an example method 300 for registering a password-based encryption sender or recipient on the system 100 is shown.

At operation 302, the middleware router 108 receives a request for access to the system 100. At operation 304, a determination is made whether the requestor has an account on the system 100.

If so, control is passed to operation 308, and the requestor is prompted for authentication credentials, such as a password, smartcard, etc. Next, at operation 310, a determination is made whether the credentials are correct, If so, control is passed to operation 312, If not, control is passed back to operation 308 to re-prompt for the authentication credentials.

If an account does not exist at operation 304, control is instead passed to operation 306. At this point, the account is created based upon information from the requestor. This information can be collected by the system 100 or through an API for the system 100. Such example information can include the following:
type of encryption being used (e.g. PSK, RSA, PBE, etc.);
data transfer method (push or pull);
(for push methods) push endpoint URL & format;
notification method (e.g., Webhook, SMS, Email, etc.);
notification location (e.g., URL, phone number, email address, etc.); and
authentication credentials (e.g., password).

When a recipient is registered with the system 100, the recipient is assigned a universally unique identifier (UUID), which is used to send data to that recipient.

Control is then passed to operation 312, and the password from the requestor is confirmed. Next, at operation 314, a key pair for the requestor is generated, and the private key is secured at operation 316 with a key wrap algorithm.

Finally, at operation 318, the requestor is registered with the system 100 and is ready to send and/or receive secured data through the middleware router 108.

Generally, to send secured data to the recipient computing device 104 through the middleware router 108, the sender computing device 102 must define at least the following:
origin—recipient UUID of sending system (sending data requires a registered recipient);
target—recipient UUID of the recipient that should receive the data;
iat—Time the message was created; and
encrypted message—the secured data being transferred.

The middleware router 108 can facilitate the sending of the secured data several ways. In one example, the intermediate recipient module 204 receives the secured data and functions to transform and route the data.

This allows the sender computing device 102 to send data in a consistent manner, and in the format that is most convenient for the sender computing device 102. This also allows the intermediate recipient module 204 to transform the data into whatever encryption mechanism and data format is required by the recipient computing device 104.

In such an example, the middleware router 108 maintains the intake recipient module 202 that accepts the following JSON message format:

```
{
  “target”:<Target Recipient UUID>,
  “message”:<Base64 Encoded message>
  “iat”: <Unix time stamp of time message was created>
  “origin”: <Sender Recipient UUID>
}
```

The intake recipient module 202 can also accept encrypted messages in the following format:

```
{
  “key”:<128 bit AES key encrypted with the intake recipient's public key>
  “message”:<Base64 encoded message JSON, encrypted with the AES key>
}
```

Note that sending encrypted data to the intake recipient module 202 requires that the sender computing device 102 can perform some basic cryptographic operations securely.

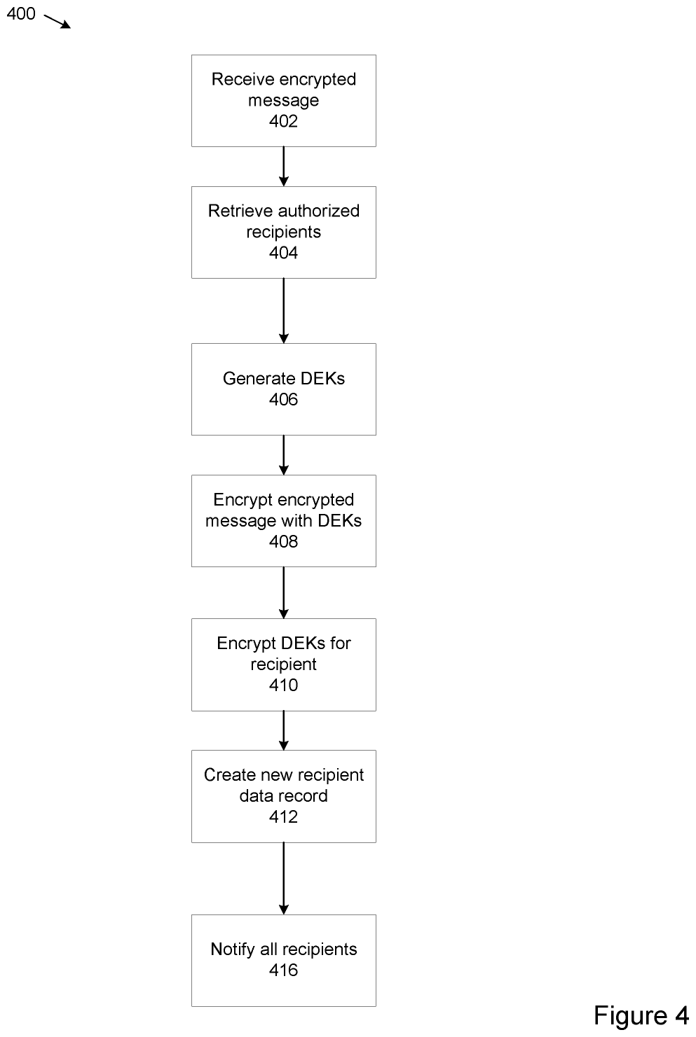

For instance, referring now to FIG. 4, an example method 400 is shown for sending the secured data using the system 100.

At operation 402, the intake recipient module 202 receives the secured data, referred to as the “encrypted message” since the contents of the secured data is not known to the middleware router 108.

Next, at operation 404, the recipient computing device 104 is retrieved by the intermediate recipient module 204 based upon the UUID for the recipient provided by the sender computing device 102. In some embodiments, multiple recipients can be defined.

Next, at operation 406, DEKs are generated, and the encrypted message is encrypted using the DEKs in operation 408.

At operation 410, the DEKs for decrypting the encrypted message are encrypted with the recipient public key and the encrypted key is stored along with the encrypted message. The record for the encrypted message is created at operation 412, and the recipient computing device 104 is notified at operation 416.

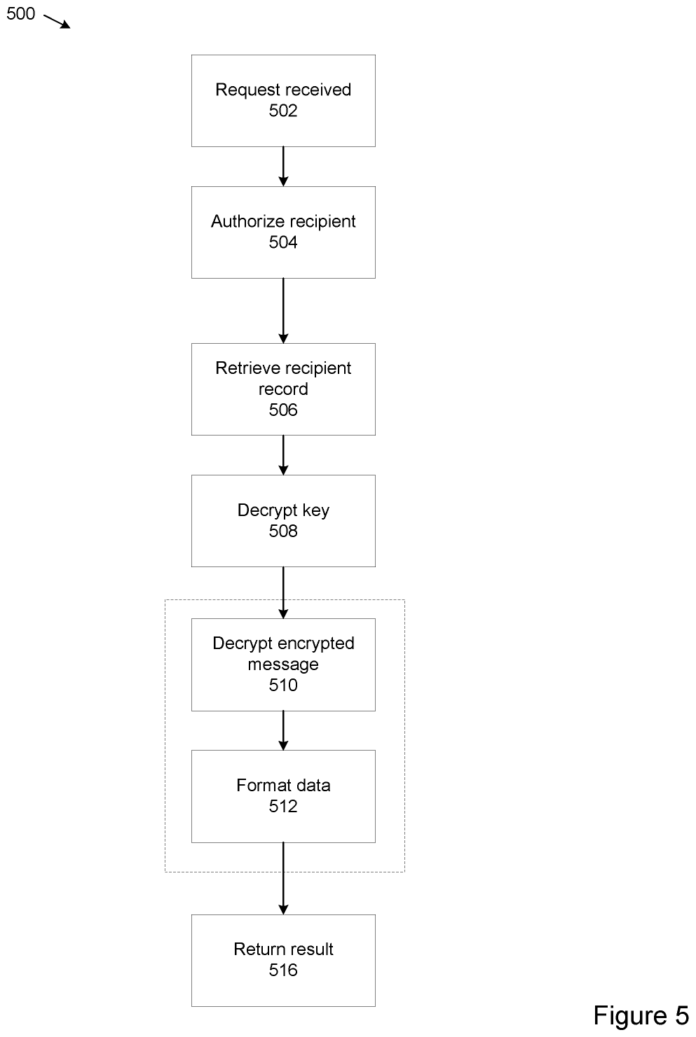

Referring now to FIG. 5, an example method 500 is shown for the recipient computing device 104 to receive the secured data.

At operation 502, a request is received from the recipient computing device 104 for the secured data including the encrypted message. Next, at operation 504, the middleware router 108 authenticates the recipient computing device 104.

Upon authentication, control is passed to operation 506, and the record associated with the secured data is retrieved. Then, at operation 508, the DEK is decrypted, and the DEK is then used to decrypt the encrypted message at operation 510. Finally, the secured data is formatted at operation 512, and the formatted data is returned to the recipient computing device 104 at operation 516.

In another method for sending the secured data using the system 100, operations 510 and 512 are optional. In this instance, the encrypted message can be delivered directly to the recipient computing device 104 without being decrypted by the middleware router 108. In such a scenario, the recipient computing device 104 is programmed to decrypt the encrypted message using the appropriate encryption keys.

Such a scenario provides end-to-end encrypted data via the middleware router 108, which can be the most secure way to transfer the secured data. In this instance, a Software Development Kit (SDK), provided by the middleware router 108, running on the sender computing device 102 retrieves the public portion of the key bundle for the recipient computing device 104 via an input module and creates a standard encrypted package which is routed by an output module to the recipient computing device 104. In this scenario, the intermediate recipient module 204 performs no data transformation, and the secured data cannot be decrypted by the middleware router 108.

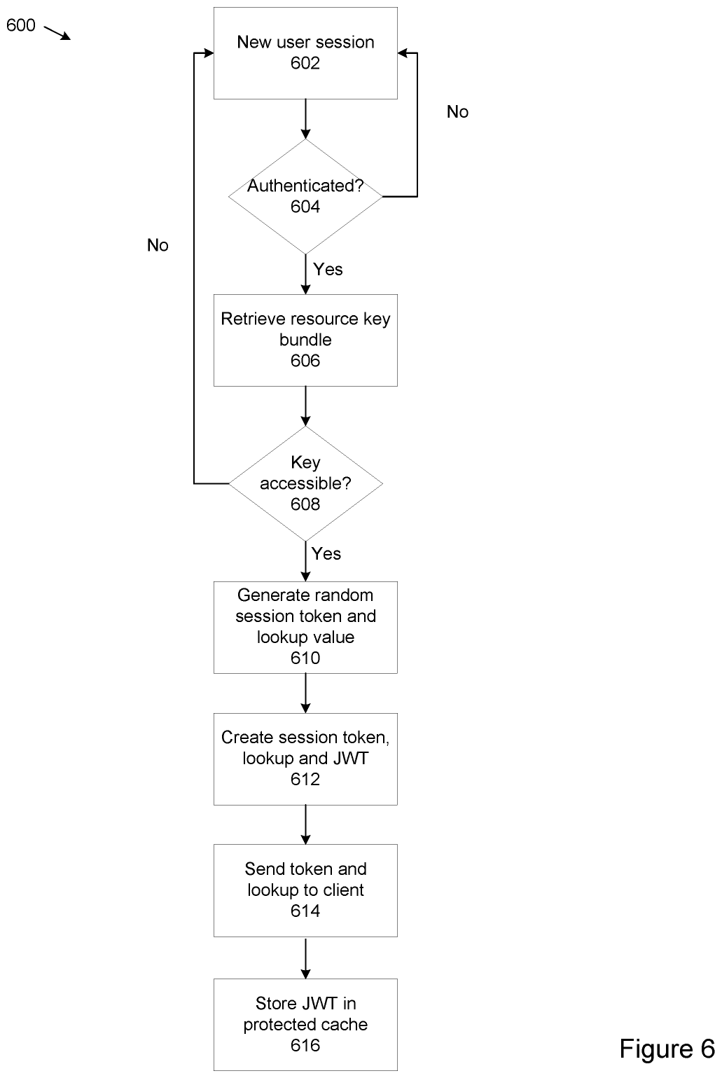

As noted, there are various ways of sending and receiving the secured data using the system 100. In FIG. 6, an example method 600 of the system 100 addresses security issues associated with accessing the secured data using a web application. This solution addresses security problems by allowing the recipient computing device 104 to authenticate once and maintain an arbitrary length session and view protected data without needing to re-enter its password with every request, and without storing a plain-text secret (password or encryption key) on the middleware router 108 or the recipient computing device 104.

At operation 602 of the method 600, a new user session is requested. Next, at operation 604, the recipient computing device 104 is authenticated (e.g., using a username and password, smart card, etc.). The recipient computing device 104 further provides the root secret (e.g., a password/passphrase, symmetric or asymmetric encryption key).

Next, at operation 606, the middleware router 108 retrieves the recipient key bundle and decrypts the KEK with the root secret. At operation 608, a determination is made whether the necessary keys are available. If not, control is passed back to operation 602.

Otherwise, control is passed to operation 610, and the middleware router 108 generates a random 256 bit token and a random 192 bit lookup value. Next, at operation 612, the middleware router 108 generates a JSON Web Token (JWT) containing the following key value pairs:
key: <Base64 encoded KEK>
id: <Hash of client request biometrics>

At operation 614, the lookup value and JWT are sent to the recipient computing device 104 for storage in an encrypted cookie on a client browser of the recipient computing device 104. Finally, at operation 616, the JWT is placed in a protected cache on the middleware router 108 using the lookup value as the key.

In this scenario, the secured data is accessible without requiring the root secret with every request, and the middleware router 108 never stores the complete set of information required to decrypt data. Compromise of any single party does not compromise data confidentiality. In other words, an attacker would need to compromise both the middleware router 108 and the recipient computing device 104 to decrypt the secured data. Additionally, the id value stored in the JWT can be used as protection against session fixation attacks by comparing the hash client system biometrics against the hash from the original request stored in the session JWT.

Referring now to FIG. 7, in the examples provided, the various components of the middleware router 108 can be implemented on one or more computing devices. The computing devices can be configured in various ways, such as the traditional client/server configuration.

Each computing device can include various components, including a memory 702, a central processing unit (or processor) 704, a mass storage device 706, a network interface unit or card 708 configured to communicate through the network 720, an input/output unit 710 (e.g., video interface, a display unit, and an external component interface). In other embodiments, computing devices are implemented using more or fewer hardware components. For instance, in another example embodiment, a computing device does not include a video interface, a display unit, an external storage device, or an input device.

The term computer readable media as used herein may include computer storage media, which can include random access memory 712 and/or read only memory 714. Computer storage media may include volatile and nonvolatile, removable and non-removable media implemented in any method or technology for storage of information, such as computer readable instructions, data structures, program modules, or other data. The memory includes one or more computer storage media capable of storing data and/or instructions.

As used in this document, a computer storage medium is a device or article of manufacture that stores data and/or software instructions readable by a computing device. In different embodiments, the memory is implemented in different ways. For instance, in various embodiments, the memory is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system includes one or more physical integrated circuits that selectively execute software instructions. In various embodiments, the processing system is implemented in various ways. For example, the processing system can be implemented as one or more processing cores. In this example, the processing system can comprise one or more Intel microprocessors. In another example, the processing system can comprise one or more separate microprocessors.

The secondary storage device includes one or more computer storage media. The secondary storage device stores data and software instructions not directly accessible by the processing system. In other words, the processing system performs an I/O operation to retrieve data and/or software instructions from the secondary storage device. In various embodiments, the secondary storage device is implemented by various types of computer-readable data storage media. For instance, the secondary storage device may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card enables the computing device to send data to and receive data from a communication network. In different embodiments, the network interface card is implemented in different ways. For example, in various embodiments, the network interface card is implemented as an Ethernet interface, a token-ring network interface, a fiber optic network interface, a wireless network interface (e.g., Wi-Fi, WiMAX, etc.), or another type of network interface.

The video interface enables the computing device to output video information to the display unit. In different embodiments, the video interface is implemented in different ways. For instance, in one example embodiment, the video interface is integrated into a motherboard of the computing device. In another example embodiment, the video interface is a video expansion card. In various embodiments, the display unit can be a cathode-ray tube display, an LCD display panel, a plasma screen display panel, a touch-sensitive display panel, an LED screen, a projector, or another type of display unit. In various embodiments, the video interface communicates with the display unit in various ways. For example, the video interface can communicate with the display unit via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The external component interface enables the computing device to communicate with external devices. In various embodiments, the external component interface is implemented in different ways. For example, the external component interface can be a USB interface, a FireWire interface, a serial port interface, a parallel port interface, a PS/2 interface, and/or another type of interface that enables the computing device to communicate with external devices. In different embodiments, the external component interface enables the computing device to communicate with different external components. For example, the external component interface can enable the computing device to communicate with external storage devices, input devices, speakers, phone charging jacks, modems, media player docks, other computing devices, scanners, digital cameras, a fingerprint reader, and other devices that can be connected to the computing device.

Example types of external storage devices include, but are not limited to, magnetic tape drives, flash memory modules, magnetic disk drives, optical disc drives, flash memory units, zip disk drives, optical jukeboxes, and other types of devices comprising one or more computer storage media. Example types of input devices include, but are not limited to, keyboards, mice, trackballs, stylus input devices, keypads, microphones, joysticks, touch-sensitive display screens, and other types of devices that provide user input to the computing device.

The memory stores various types of data and/or software instructions. For instance, in one example, the memory stores a Basic Input/Output System (BIOS), and an operating system 716. The BIOS includes a set of software instructions that, when executed by the processing system, cause the computing device to boot up. The operating system includes a set of software instructions that, when executed by the processing system, cause the computing device to provide an operating system that coordinates the activities and sharing of resources of the computing device, including one or more possible software applications 718.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for transmitting secured data, the system comprising:
a processor;
memory encoding instructions which, when executed by the processor, cause the processor to:
receive the secured data from a sender for a recipient, the secured data being encrypted using a first encryption mechanism;
retrieve a second encryption mechanism associated with the recipient;
transform the secured data using the second encryption mechanism;
notify the recipient of the secured data; and
deliver the secured data to the recipient, the secured data being encrypted using the second encryption mechanism.

2. The system of claim 1, comprising further instructions which, when executed by the processor, cause the processor to:
authenticate the sender;
generate a first key pair for the first encryption mechanism; and
secure a private key of the first key pair.

3. The system of claim 1, wherein a message from the sender includes:
an origin universally unique identifier that uniquely identifies the sender of the secured data;
a target universally unique identifier that uniquely identifies the recipient of the secured data; and
the secured data being sent by the sender to the recipient.

4. The system of claim 1, wherein the secured data is received from the sender by a middleware router, and wherein the secured data cannot be decrypted by the middleware router.

5. The system of claim 4, wherein the secured data remains encrypted as the secured data passes from the sender, through the middleware router, and to the recipient.

6. The system of claim 1, comprising further instructions which, when executed by the processor, cause the processor to notify the recipient of the secured data.

7. The system of claim 6, comprising further instructions which, when executed by the processor, cause the processor to allow the recipient to select a type of notification.

8. The system of claim 1, comprising further instructions which, when executed by the processor, cause the processor to:
decrypt a data encryption key;
use the data encryption key to decrypt the secured data; and
transform the secured data for the recipient.

9. The system of claim 1, comprising further instructions which, when executed by the processor, cause the processor to generate a token for the recipient to use to access the secured data.

10. The system of claim 1, comprising further instructions which, when executed by the processor, cause the processor to receive the secured data from the sender through an application programming interface.

11. A method for transmitting secured data, the method comprising:
receiving the secured data from a sender for a recipient, the secured data being encrypted using a first encryption mechanism;
retrieving a second encryption mechanism associated with the recipient;
transforming the secured data using the second encryption mechanism;
notifying the recipient of the secured data; and
delivering the secured data to the recipient, the secured data being encrypted using the second encryption mechanism.

12. The method of claim 11, further comprising:
authenticating the sender;
generating a first key pair for the first encryption mechanism; and
securing a private key of the first key pair.

13. The method of claim 11, wherein a message from the sender includes:
an origin universally unique identifier that uniquely identifies the sender of the secured data;
a target universally unique identifier that uniquely identifies the recipient of the secured data; and
the secured data being sent by the sender to the recipient.

14. The method of claim 11, wherein the secured data is received from the sender by a middleware router, and wherein the secured data cannot be decrypted by the middleware router.

15. The method of claim 14, wherein the secured data remains encrypted as the secured data passes from the sender, through the middleware router, and to the recipient.

16. The method of claim 11, further comprising notifying the recipient of the secured data.

17. The method of claim 16, further comprising allowing the recipient to select a type of notification.

18. The method of claim 11, further comprising:
decrypting a data encryption key;
using the data encryption key to decrypt the secured data; and
transforming the secured data for the recipient.

19. The method of claim 11, further comprising generating a token for the recipient to use to access the secured data.

20. The method of claim 11, further comprising receiving the secured data from the sender through an application programming interface.
